(19) United States
(12) Patent Application Publication
(10) Pub. No.: US 2018/0009663 A1
(43) Pub. Date: Jan. 11, 2018

(54) METHOD FOR DRYING CATALYTIC OXIDATION FURNACE

(71) Applicant: WUHAN KAIDI ENGINEERING TECHNOLOGY RESEARCH INSTITUTE CO., LTD., Wuhan (CN)

(72) Inventors: Yilong CHEN, Wuhan (CN); Yanfeng ZHANG, Wuhan (CN); Pingyu KUAI, Wuhan (CN); Wentang TIAN, Wuhan (CN); Daxiang WANG, Wuhan (CN)

(21) Appl. No.: 15/713,689

(22) Filed: Sep. 24, 2017

Related U.S. Application Data
(63) Continuation-in-part of application No. PCT/CN2016/074636, filed on Feb. 26, 2016.

(30) Foreign Application Priority Data
Mar. 25, 2015 (CN) 201510133393.8

(51) Int. Cl. C01B 3/40

(52) U.S. Cl. CPC C01B 3/40; C01B 32/40; C01B 2203/1082; C01B 2203/0261; C01B 2203/1241; C01B 2203/1017

(57) ABSTRACT

A method for drying a catalytic oxidation furnace, the method including: 1) charging a feed gas including oxygen and natural gas, and a temperature control gas to a catalytic oxidation furnace loaded with a catalyst; 2) preheating a mixed gas including the feed gas and the temperature control gas to increase the temperature of the mixed gas, and stopping the preheating when the temperature of the mixed gas achieves a temperature adapted to trigger the oxidation reaction of the mixed gas; and 3) within the molar ratio of the temperature control gas to the feed gas being 0.1-7:1.3-1.6, reducing the molar ratio of the temperature control gas to the feed gas such that the rise of the temperature of the mixed gas conforms to the temperature rising rate of the drying-out curve of a heat insulation refractory material of the catalytic oxidation furnace.

### CROSS-REFERENCE TO RELATED APPLICATIONS

This application is a continuation-in-part of International Patent Application No. PCT/CN2016/074636 with an international filing date of Feb. 26, 2016, designating the United States, now pending, and further claims foreign priority to Chinese Patent Application No. 201510133393.8 filed Mar. 25, 2015. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

### Field of the Invention

The invention relates to a method for drying an adiabatic catalytic oxidation furnace.

### Description of the Related Art

Typically, catalytic oxidation of natural gas is implemented in an adiabatic catalytic oxidation furnace. In general, the inner wall of the furnace is made of heat insulation refractory materials, and the furnace can achieve a working temperature of 1300° C. or above.

To ensure the safe usage of the adiabatic catalytic oxidation furnace, the reaction temperature in the furnace should be controlled to conform to the drying-out curve of the heat insulation refractory materials of the furnace. In use, when the furnace is heated and the temperature of the feed gas in the furnace rises to a critical temperature, the catalytic reaction is triggered and a large amount of heat is released in a short time leading to a sharp rise in temperature. Conventionally, the temperature rise is difficult to control. The inner wall of the furnace is usually made of fragile materials, and the sharp rise of the wall temperature results in furnace wall cracks, adversely affecting the working efficiency of the furnace.

### SUMMARY OF THE INVENTION

In view of the above-described problems, it is one objective of the invention to provide a method for drying an adiabatic catalytic oxidation furnace; the method buffers the temperature fluctuations in the catalytic oxidation furnace during the drying process, thereby avoiding the crack of the refractory material liner of the furnace and ensuring the smooth proceeding of the catalytic oxidation.

To achieve the above objective, in accordance with one embodiment of the invention, there is provided a method for drying an adiabatic catalytic oxidation furnace, the method comprising:
1) charging a feed gas comprising oxygen and natural gas, and a temperature control gas capable of reducing a reaction temperature rising rate to a catalytic oxidation furnace loaded with a catalyst, wherein a molar ratio of the oxygen to the natural gas in the feed gas is 0.3-0.6:1, and a molar ratio of the temperature control gas to the feed gas is 0.1-7:1.3-1.6;
2) preheating a mixed gas comprising the feed gas and the temperature control gas to increase a temperature of the mixed gas, and stopping the preheating when the temperature of the mixed gas achieves a temperature adapted to trigger an oxidation reaction of the mixed gas; and
3) within the molar ratio of the temperature control gas to the feed gas being 0.1-7:1.3-1.6, reducing the molar ratio of the temperature control gas to the feed gas so that a rise of the temperature of the mixed gas conforms to a temperature rising rate of a drying-out curve of a heat insulation refractory material of the catalytic oxidation furnace, and stopping charging the temperature control gas when the reaction temperature achieves the working temperature of the catalytic oxidation furnace.

In a class of this embodiment, in 3), while reducing the molar ratio of the temperature control gas to the feed gas, the method further comprises adjusting the molar ratio of the oxygen to the natural gas in the feed gas such that the rise of the temperature of the mixed gas conforms to the temperature rising rate of the drying-out curve of the heat insulation refractory material of the catalytic oxidation furnace.

In a class of this embodiment, in 1), the temperature control gas is an inert gas, N₂, CO₂, water vapor, or a mixture thereof.

In a class of this embodiment, in 2), the temperature adapted to trigger an oxidation reaction of the mixed gas is between 300 and 600° C.

In a class of this embodiment, in 3), while reducing the molar ratio of the temperature control gas to the feed gas, the method further comprises increasing the molar ratio of the oxygen to the natural gas in the feed gas such that the rise of the temperature of the mixed gas conforms to the temperature rising rate of the drying-out curve of the heat insulation refractory material of the catalytic oxidation furnace.

In a class of this embodiment, in 3), the molar ratio of the temperature control gas to the feed gas is reduced from 7:1.3-1.6 to 0-5:1.3-1.6 when the temperature of the mixed gas is increased to 750° C. from 280° C.

In a class of this embodiment, in 3), the molar ratio of the temperature control gas to the feed gas is reduced from 5.1-7:1.4-1.6 to 0-5:1.4-1.6, and the molar ratio of the oxygen to the natural gas in the feed gas is increased from 0.3-0.4:1 to 0.41-0.6:1 when the temperature of the mixed gas is increased to 750° C. from 280° C.

Advantages of the method for drying an adiabatic catalytic oxidation furnace of the present disclosure are summarized as follows:

1. In the method of the present disclosure, the temperature control gas, which has no combustion or combustion-supporting characteristics and is adapted to reduce the reaction rate and capable of taking away part of reaction heat, is added to the feed gas. Through appropriately adjusting the molar ratio of the temperature control gas during the heating stage, the temperature fluctuation range in the oxidation furnace during the online drying/starting period is effectively controlled, avoiding the shock heating in the furnace during oxidation reaction, ensuring the rise of the temperature of the mixed gas conforms to the temperature rising rate of a drying-out curve of the heat insulation refractory material of the catalytic oxidation furnace, achieving the temperature control of the catalytic oxidation furnace, avoiding the crack of the heat insulation refractory materials, protecting the catalytic oxidation furnace and making it transit smoothly to a normal running state.

2. The feed gas is mixed with the temperature control gas without combustion characteristics or combustion-supporting characteristics, and the reaction temperature is controlled by appropriately controlling the mole proportion of the temperature control gas and adjusting the molar ratio of the natural gas to the oxygen during the heating stage; accordingly, the invention provides a controllable and relatively moderate method for drying an adiabatic catalytic oxidation furnace, avoiding reduction or failure of efficiency of the oxidation furnace due to crack.

3. The method in the present disclosure can control the range of the temperature rise during the online drying/starting process and reduce the risk of carbon deposit of the adiabatic catalytic oxidation furnace, so that the oxidation furnace can transit smoothly to a normal running state.

### BRIEF DESCRIPTION OF THE DRAWINGS

FIG. 1 is a drying-out curve of a heat insulation refractory material in the prior art;

FIG. 2 is a change chart of temperature of a gas discharged from a catalyst bed with the variation of the flow rate of N₂ in Example 1;

FIG. 3 is a change chart of temperature of a gas discharged from a catalyst bed with the variation of the flow rate of Helium in Example 2;

FIG. 4 is a change chart of temperature of a gas discharged from a catalyst bed with the variation of the flow rate of CO₂ in Example 3;

FIG. 5 is a change chart of temperature of a gas discharged from a catalyst bed with the variation of the flow rate of N₂ in Example 4;

FIG. 6 is a change chart of temperature of a gas discharged from a catalyst bed with the variation of the flow rate of H₂O in Example 5; and

FIG. 7 is a change chart of temperature of a gas discharged from a catalyst bed with the variation of the flow rate of Argon in Example 6.

### DETAILED DESCRIPTION OF THE EMBODIMENTS

For further illustrating the invention, experiments detailing a method for drying an adiabatic catalytic oxidation furnace are described hereinbelow combined with the drawings. It should be noted that the following examples are intended to describe and not to limit the invention.

### EXAMPLE 1

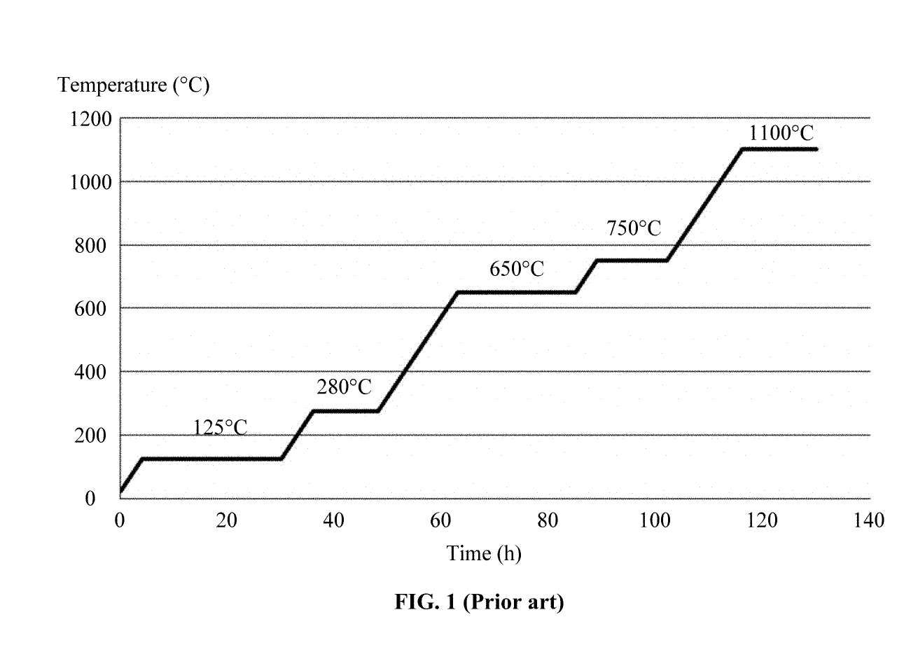

First, N₂, natural gas and oxygen were injected to a dried catalytic oxidation furnace loaded with a noble metal catalyst, where the natural gas comprised more than 99.9% (v/v) methane; the flow rate of the natural gas was 1 kmol/h; the purity of the oxygen exceeded 99.9%; the flow rate of the oxygen was 0.6 kmol/h; the purity of the N₂ exceeded 99.9%; and the flow rate of the N₂ was 7 kmol/h. Thereafter, the mixed gas comprising the N₂, natural gas and oxygen was preheated to 300° C. to trigger the catalytic oxidation; stop preheating, and gradually reduce the flow rate of the nitrogen until the flow rate of the nitrogen became 0, such that the rise of the reaction temperature of the mixed gas conforms to the temperature rising rate of the designed drying-out curve of the heat insulation refractory material of the catalytic oxidation furnace of natural gas. Specifically, the temperature rose steadily to 1115° C. which was the normal working temperature of the catalytic oxidation furnace. The drying-out curve of the heat insulation refractory material of the catalytic oxidation furnace of natural gas is shown in FIG. 1.

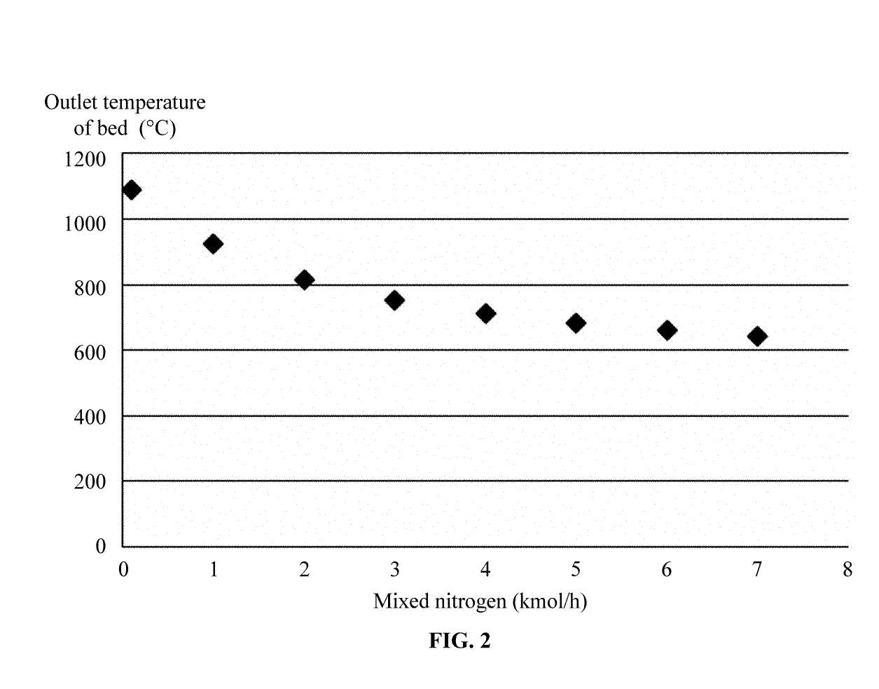

During the drying stage, with the reduction of the flow rate of the N₂, the temperature of the gas discharged from the catalyst bed is shown in FIG. 2 when the flow rates of the N₂ are 7 kmol/h, 6 kmol/h, 5 kmol/h, 4 kmol/h, 3 kmol/h, 2 kmol/h, 1 kmol/h and 0.1 kmol/h. As shown in FIG. 2, the gas temperature in the furnace increases steadily with the reduction of the flow rate of the N₂, without shock heating; and the molar ratio of the natural gas to the oxygen to the N₂ is shown in Table 1 in each insulating stage of drying.

TABLE 1

| | Drying temperature/° C. | | | | |
|---|---|---|---|---|---|
| | 125 | 280 | 650 | 750 | 1100 |
| Example 1 | 1:0.6:7 | 1:0.6:7 | 1:0.6:6.5 | 1:0.6:3 | 1:0.6:0.05 |
| CH₄:O₂:N₂ | | | | | |
| Example 2 | 1:0.3:7 | 1:0.3:7 | 1:0.3:5 | 1:0.3:0.3 | — |
| CH₄:O₂:He | | | | | |
| Example 3 | 1:0.4:7 | 1:0.4:7 | 1:0.4:1 | 1:0.4:0.1 | — |
| CH₄:O₂:CO₂ | | | | | |
| Example 4 | 1:0.4:4 | 1:0.4:4 | 1:0.45:3 | 1:0.51:1 | 1:0.6:0.05 |
| CH₄:O₂:N₂ | | | | | |
| Example 5 | 1:0.4:4 | 1:0.4:4 | 1:0.4:2 | 1:0.47:1.5 | 1:0.56:0.3 |
| CH₄:O₂:H₂O | | | | | |
| Example 6 | 1:0.4:3.5 | 1:0.4:3.5 | 1:0.4:3 | 1:0.5:1.2 | 1:0.6:0.1 |
| CH₄:O₂:Ar | | | | | |

### EXAMPLE 2

First, Helium, natural gas and oxygen were injected to a dried catalytic oxidation furnace loaded with a noble metal catalyst, where the natural gas comprised more than 99.9% (v/v) methane; the flow rate of the natural gas was 1 kmol/h; the purity of the oxygen exceeded 99.9%; the flow rate of the oxygen was 0.3 kmol/h; the purity of the Helium exceeded 99.9%; and the flow rate of the Helium was 7 kmol/h. Thereafter, the mixed gas comprising the Helium, natural gas and oxygen was preheated to 550° C. to trigger the catalytic oxidation; stop preheating, and gradually reduce the flow rate of the

Helium until the flow rate of the Helium became 0, such that the rise of the reaction temperature of the mixed gas conforms to the temperature rising rate of the designed drying-out curve of the heat insulation refractory material of the catalytic oxidation furnace of natural gas. Specifically, the temperature rose steadily to 760° C. which was the normal working temperature of the catalytic oxidation furnace. The drying-out curve of the heat insulation refractory material of the catalytic oxidation furnace of natural gas is shown in FIG. 1.

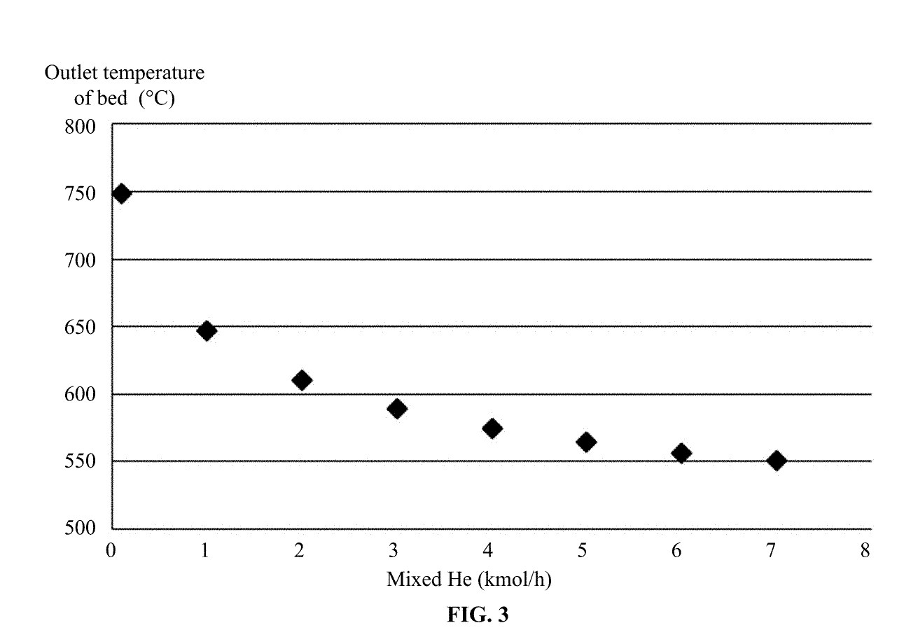

During the drying stage, with the reduction of the flow rate of the Helium, the temperature of the gas discharged from the catalyst bed is shown in FIG. 3 when the flow rates of the Helium are 7 kmol/h, 6 kmol/h, 5 kmol/h, 4 kmol/h, 3 kmol/h, 2 kmol/h, 1 kmol/h and 0.1 kmol/h. As shown in FIG. 3, the gas temperature in the furnace increases steadily with the reduction of the flow rate of the Helium, without shock heating; and the molar ratio of the natural gas to the oxygen to the Helium is shown in Table 1 in each insulating stage of drying.

### EXAMPLE 3

First, CO₂, natural gas and oxygen were injected to a dried catalytic oxidation furnace loaded with a noble metal catalyst, where the natural gas comprised more than 99.9% (v/v) methane; the flow rate of the natural gas was 1 kmol/h; the purity of the oxygen exceeded 99.9%; the flow rate of the oxygen was 0.4 kmol/h; the purity of the CO₂ exceeded 99.9%; and the flow rate of the CO₂ was 7 kmol/h. Thereafter, the mixed gas comprising the CO₂, natural gas and oxygen was preheated to 600° C. to trigger the catalytic oxidation; stop preheating, and gradually reduce the flow rate of the CO₂ until the flow rate of the CO₂ became 0, such that the rise of the reaction temperature of the mixed gas conforms to the temperature rising rate of the designed drying-out curve of the heat insulation refractory material of the catalytic oxidation furnace of natural gas. Specifically, the temperature rose steadily to 760° C. which was the normal working temperature of the catalytic oxidation furnace. The drying-out curve of the heat insulation refractory material of the catalytic oxidation furnace of natural gas is shown in FIG. 1.

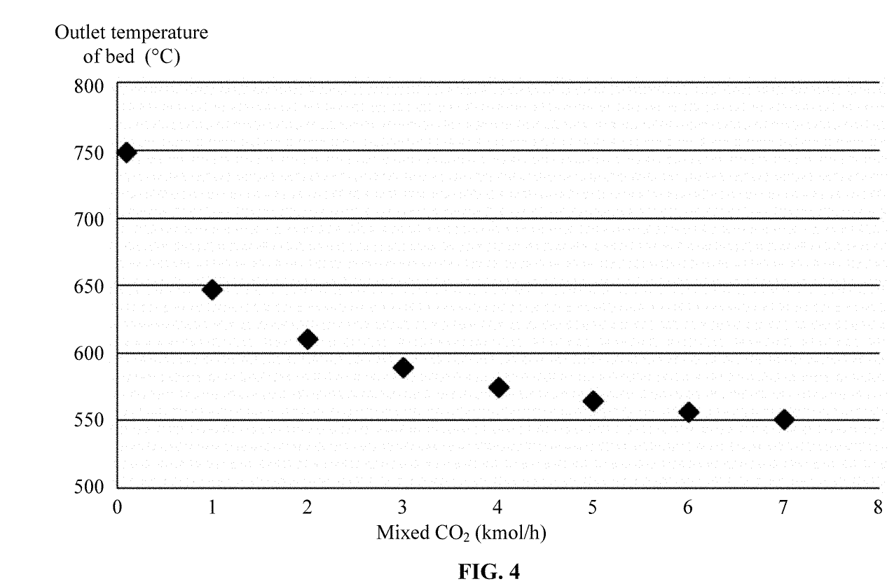

During the drying stage, with the reduction of the flow rate of the CO₂, the temperature of the gas discharged from the catalyst bed is shown in FIG. 4 when the flow rates of the CO₂ are 7 kmol/h, 6 kmol/h, 5 kmol/h, 4 kmol/h, 3 kmol/h, 2 kmol/h, 1 kmol/h and 0.1 kmol/h. As shown in FIG. 4, the gas temperature in the furnace increases steadily with the reduction of the flow rate of the CO₂, without shock heating; and the molar ratio of the natural gas to the oxygen to the CO₂ is shown in Table 1 in each insulating stage of drying.

### EXAMPLE 4

First, N₂, natural gas and oxygen were injected to a dried catalytic oxidation furnace loaded with a noble metal catalyst, where the natural gas comprised more than 99.9% (v/v) methane; the flow rate of the natural gas was 1 kmol/h; the purity of the oxygen exceeded 99.9%; the flow rate of the oxygen was 0.3 kmol/h; the purity of the N₂ exceeded 99.9%; and the flow rate of the N₂ was 7 kmol/h. Thereafter, the mixed gas comprising the N₂, natural gas and oxygen was preheated to 300° C. to trigger the catalytic oxidation; stop preheating, and gradually reduce the flow rate of the nitrogen and regulate the molar ratio of the natural gas to the oxygen, such that the rise of the reaction temperature of the mixed gas conforms to the temperature rising rate of the designed drying-out curve of the heat insulation refractory material of the catalytic oxidation furnace of natural gas. Specifically, the temperature rose steadily to 1115° C. which was the normal working temperature of the catalytic oxidation furnace, the flow rate of the nitrogen became 0, and the molar ratio of the natural gas to the oxygen was 1:0.6. The drying-out curve of the heat insulation refractory material of the catalytic oxidation furnace of natural gas is shown in FIG. 1.

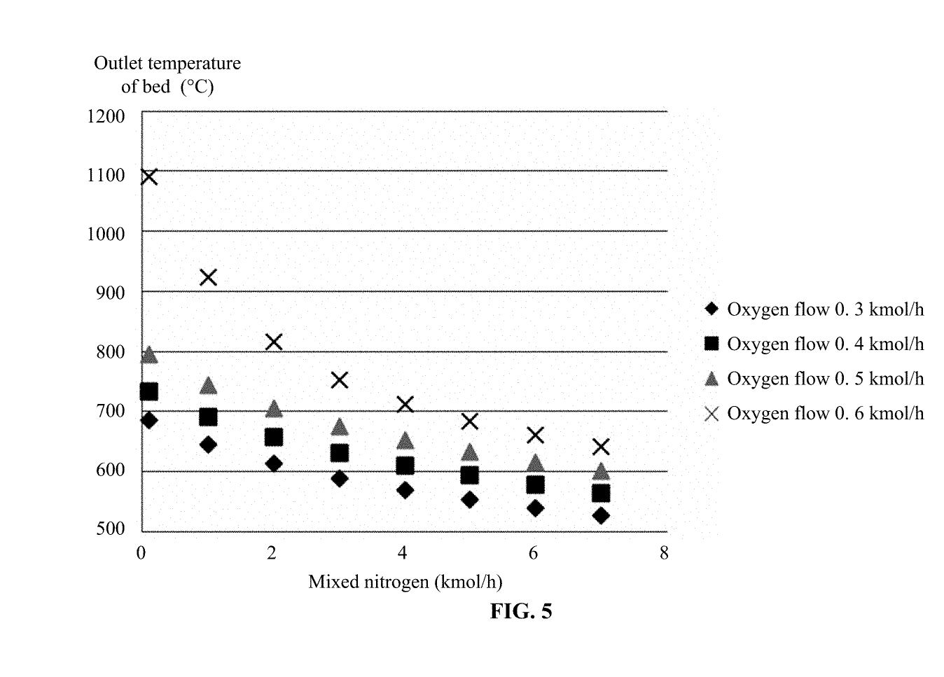

During the drying stage, with the reduction of the flow rate of the N₂ and the increase of the flow rate of the oxygen, the temperature of the gas discharged from the catalyst bed is shown in FIG. 5 when the flow rates of the N₂ are 7 kmol/h, 6 kmol/h, 5 kmol/h, 4 kmol/h, 3 kmol/h, 2 kmol/h, 1 kmol/h and 0.1 kmol/h, and the flow rates of the oxygen are 0.3 kmol/h, 0.4 kmol/h, 0.5 kmol/h, and 0.6 kmol/h. As shown in FIG. 5, the gas temperature in the furnace increases steadily with the reduction of the flow rate of the N₂ and the increase of the flow rate of the oxygen, without shock heating; and the molar ratio of the natural gas to the oxygen to the N₂ is shown in Table 1 in each insulating stage of drying.

### EXAMPLE 5

First, water vapor, natural gas and oxygen were injected to a dried catalytic oxidation furnace loaded with a noble metal catalyst, where the natural gas comprised more than 99.9% (v/v) methane; the flow rate of the natural gas was 1 kmol/h; the purity of the oxygen exceeded 99.9%; the flow rate of the oxygen was 0.3 kmol/h; the purity of the water vapor exceeded 99.9%; and the flow rate of the water vapor was 7 kmol/h. Thereafter, the mixed gas comprising the water vapor, natural gas and oxygen was preheated to 600° C. to trigger the catalytic oxidation; stop preheating, and gradually reduce the flow rate of the water vapor and regulate the molar ratio of the natural gas to the oxygen, that is, gradually increase the molar percentage of the oxygen, such that the rise of the reaction temperature of the mixed gas conforms to the temperature rising rate of the designed drying-out curve of the heat insulation refractory material of the catalytic oxidation furnace of natural gas. Specifically, the temperature rose steadily to 1342° C. which was the normal working temperature of the catalytic oxidation furnace, the flow rate of the water vapor became 0, and the molar ratio of the natural gas to the oxygen was 1:0.6. The drying-out curve of the heat insulation refractory material of the catalytic oxidation furnace of natural gas is shown in FIG. 1.

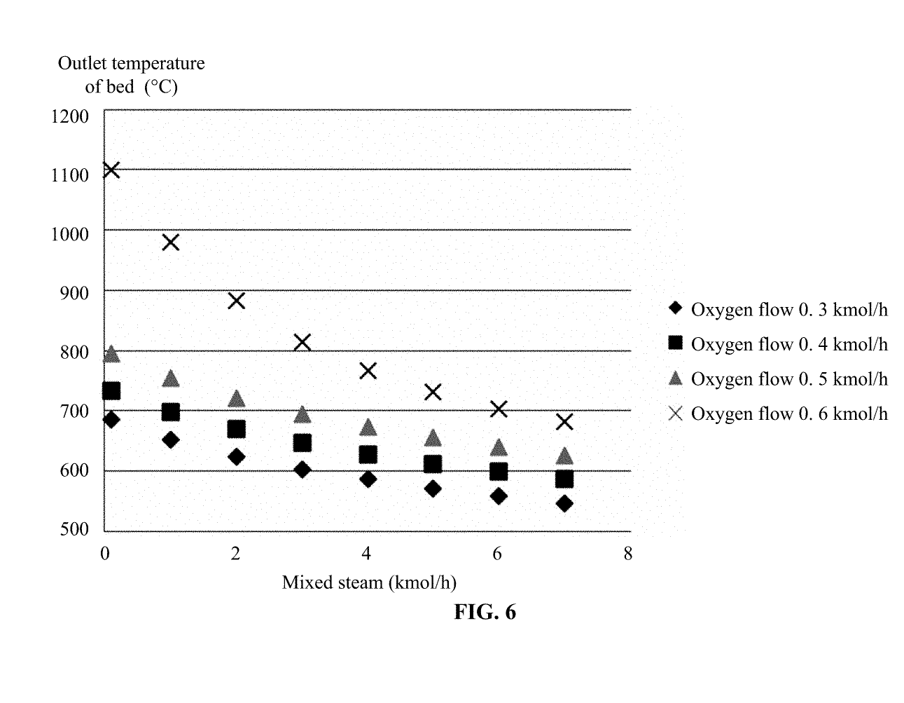

During the drying stage, with the reduction of the flow rate of the water vapor and the increase of the flow rate of the oxygen, the temperature of the gas discharged from the catalyst bed is shown in FIG. 6 when the flow rates of the water vapor are 7 kmol/h, 6 kmol/h, 5 kmol/h, 4 kmol/h, 3 kmol/h, 2 kmol/h, 1 kmol/h and 0.1 kmol/h, and the flow rates of the oxygen are 0.3 kmol/h, 0.4 kmol/h, 0.5 kmol/h, and 0.6 kmol/h. As shown in FIG. 6, the gas temperature in the furnace increases steadily with the reduction of the flow rate of the water vapor and the increase of the flow rate of the oxygen, without shock heating; and the molar ratio of the natural gas to the oxygen to the water vapor is shown in Table 1 in each insulating stage of drying.

### EXAMPLE 6

First, Argon, natural gas and oxygen were injected to a dried catalytic oxidation furnace loaded with a noble metal catalyst, where the natural gas comprised more than 99.9% (v/v) methane; the flow rate of the natural gas was 1 kmol/h; the purity of the oxygen exceeded 99.9%; the flow rate of the oxygen was 0.3 kmol/h; the purity of the Argon exceeded 99.9%; and the flow rate of the Argon was 7 kmol/h. Thereafter, the mixed gas comprising the Argon, natural gas and oxygen was preheated to 300° C. to trigger the catalytic oxidation; stop preheating, and gradually reduce the flow rate of the Argon and regulate the molar ratio of the natural gas to the oxygen, that is, gradually increase the molar percentage of the oxygen, such that the rise of the reaction temperature of the mixed gas conforms to the temperature rising rate of the designed drying-out curve of the heat insulation refractory material of the catalytic oxidation furnace of natural gas. Specifically, the temperature rose steadily to 1115° C. which was the normal working temperature of the catalytic oxidation furnace, the flow rate of the Argon became 0, and the molar ratio of the natural gas to the oxygen was 1:0.6. The drying-out curve of the heat insulation refractory material of the catalytic oxidation furnace of natural gas is shown in FIG. 1.

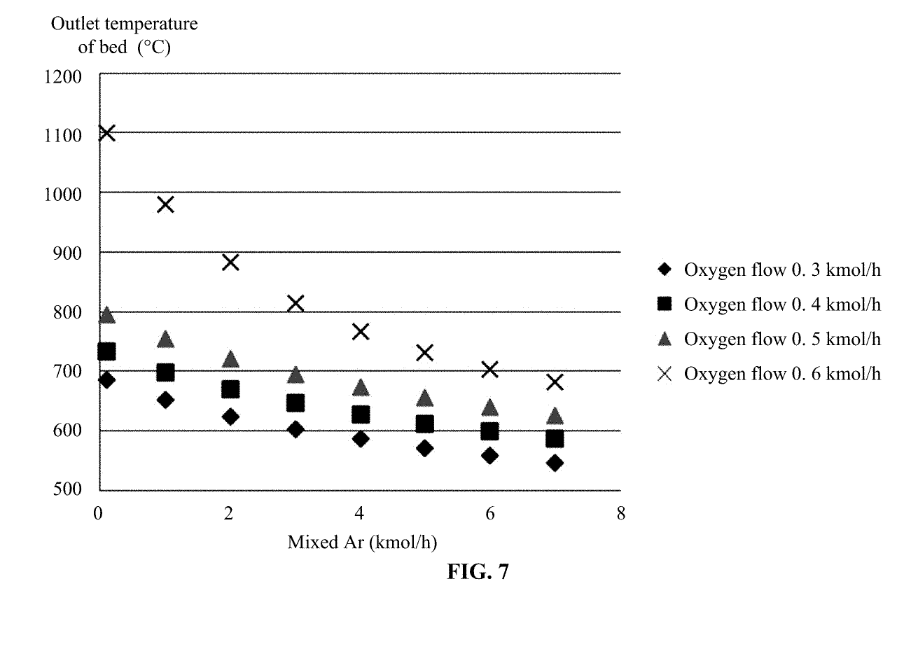

During the drying stage, with the reduction of the flow rate of the Argon and the increase of the flow rate of the oxygen, the temperature of the gas discharged from the catalyst bed is shown in FIG. 7 when the flow rates of the Argon are 7 kmol/h, 6 kmol/h, 5 kmol/h, 4 kmol/h, 3 kmol/h, 2 kmol/h, 1 kmol/h and 0.1 kmol/h, and the flow rates of the oxygen are 0.3 kmol/h, 0.4 kmol/h, 0.5 kmol/h, and 0.6 kmol/h. As shown in FIG. 7, the gas temperature in the furnace increases steadily with the reduction of the flow rate of the Argon and the increase of the flow rate of the oxygen, without shock heating; and the molar ratio of the natural gas to the oxygen to the Argon is shown in Table 1 in each insulating stage of drying.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for drying a catalytic oxidation furnace, the method comprising:
1) charging a feed gas comprising oxygen and natural gas, and a temperature control gas capable of reducing a reaction temperature rising rate to a catalytic oxidation furnace loaded with a catalyst, wherein a molar ratio of the oxygen to the natural gas in the feed gas is 0.3-0.6:1, and a molar ratio of the temperature control gas to the feed gas is 0.1-7:1.3-1.6;
2) preheating a mixed gas comprising the feed gas and the temperature control gas to increase a temperature of the mixed gas, and stopping the preheating when the temperature of the mixed gas achieves a temperature adapted to trigger an oxidation reaction of the mixed gas; and
3) within the molar ratio of the temperature control gas to the feed gas being 0.1-7:1.3-1.6, reducing the molar ratio of the temperature control gas to the feed gas so that a rise of the temperature of the mixed gas conforms to a temperature rising rate of a drying-out curve of a heat insulation refractory material of the catalytic oxidation furnace, and stopping charging the temperature control gas when the reaction temperature achieves the working temperature of the catalytic oxidation furnace.

2. The method of claim 1, wherein 3) further comprises adjusting the molar ratio of the oxygen to the natural gas in the feed gas while reducing the molar ratio of the temperature control gas to the feed gas.

3. The method of claim 1, wherein in 1), the temperature control gas is an inert gas, N₂, CO₂, water vapor, or a mixture thereof.

4. The method of claim 2, wherein in 1), the temperature control gas is an inert gas, N₂, CO₂, water vapor, or a mixture thereof.

5. The method of claim 1, wherein in 2), the temperature adapted to trigger an oxidation reaction of the mixed gas is between 300 and 600° C.

6. The method of claim 2, wherein in 2), the temperature adapted to trigger an oxidation reaction of the mixed gas is between 300 and 600° C.

7. The method of claim 1, wherein 3) further comprises increasing the molar ratio of the oxygen to the natural gas in the feed gas while reducing the molar ratio of the temperature control gas to the feed gas.

8. The method of claim 2, wherein 3) further comprises increasing the molar ratio of the oxygen to the natural gas in the feed gas while reducing the molar ratio of the temperature control gas to the feed gas.

9. The method of claim 1, wherein in 3), the molar ratio of the temperature control gas to the feed gas is reduced from 7:1.3-1.6 to 0-5:1.3-1.6 when the temperature of the mixed gas is increased to 750° C. from 280° C.

10. The method of claim 2, wherein in 3), the molar ratio of the temperature control gas to the feed gas is reduced from 7:1.3-1.6 to 0-5:1.3-1.6 when the temperature of the mixed gas is increased to 750° C. from 280° C.

11. The method of claim 1, wherein in 3), the molar ratio of the temperature control gas to the feed gas is reduced from 5.1-7:1.4-1.6 to 0-5:1.4-1.6, and the molar ratio of the oxygen to the natural gas in the feed gas is increased from 0.3-0.4:1 to 0.41-0.6:1 when the temperature of the mixed gas is increased to 750° C. from 280° C.

12. The method of claim 2, wherein in 3), the molar ratio of the temperature control gas to the feed gas is reduced from 5.1-7:1.4-1.6 to 0-5:1.4-1.6, and the molar ratio of the oxygen to the natural gas in the feed gas is increased from 0.3-0.4:1 to 0.41-0.6:1 when the temperature of the mixed gas is increased to 750° C. from 280° C.

13. The method of claim 7, wherein in 3), the molar ratio of the temperature control gas to the feed gas is reduced from 5.1-7:1.4-1.6 to 0-5:1.4-1.6, and the molar ratio of the oxygen to the natural gas in the feed gas is increased from 0.3-0.4:1 to 0.41-0.6:1 when the temperature of the mixed gas is increased to 750° C. from 280° C.

14. The method of claim 8, wherein in 3), the molar ratio of the temperature control gas to the feed gas is reduced from 5.1-7:1.4-1.6 to 0-5:1.4-1.6, and the molar ratio of the oxygen to the natural gas in the feed gas is increased from 0.3-0.4:1 to 0.41-0.6:1 when the temperature of the mixed gas is increased to 750° C. from 280° C.
